(19) United States
(12) Patent Application Publication
(10) Pub. No.: US 2026/0252504 A1
(43) Pub. Date: Aug. 27, 2026

(54) BUS NODE WITH A MICROCONTROLLER EMULATING A MEMORY CHIP

(71) Applicant: WAGO Verwaltungsgesellschaft mbH, Minden (DE)

(72) Inventors: Daniel JEROLM, Bad Essen (DE); Christian VOSS, Minden (DE)

(73) Assignee: WAGO Verwaltungsgesellschaft mbH, Minden (DE)

(21) Appl. No.: 19/545,726

(22) Filed: Feb. 20, 2026

(30) Foreign Application Priority Data
Feb. 21, 2025 (DE) 10 2025 106 600.0

(51) Int. Cl. G06F 13/16

(52) U.S. Cl. CPC G06F 13/1668; G06F 2213/16

(57) ABSTRACT

Provided is an apparatus with an interface, which is preferably configured as a bus interface, and a microcontroller emulating a memory module. The microcontroller is configured to restrict access to a memory area to authorized entities and/or to store only data from trusted sources in the memory area and/or to store only data in the memory area that has passed a data integrity and/or data authenticity test.

### FIELD

This nonprovisional application claims priority under 35 U.S.C. § 119(a) to German Patent Application No. 10 2025 106 600.0, which was filed in Germany on February 21, 2025, and which is herein incorporated by reference.

### BACKGROUND OF THE INVENTION

### Field of the Invention

The present invention relates to an apparatus with a bus interface and a microcontroller which is configured to emulate a memory chip. In particular, the present invention relates to a bus node with a microcontroller which is configured to emulate a memory chip, and a first terminal configured for input of a clock signal, and a second terminal configured for input and/or output of a data signal.

### Description of the Background Art

To prevent or at least impede unauthorized access to and, in particular, unauthorized modification of data (e.g., configuration data) of a bus node, it may be advantageous to restrict read and/or write access to the data.

### SUMMARY OF THE INVENTION

According to a first aspect, an apparatus may comprise an interface, which may preferably be configured as a bus interface, and a microcontroller, wherein the microcontroller may be configured to emulate a memory chip provided for non-volatile storage of data to be received via the interface, and to restrict access to a memory area provided for the non-volatile storage of the data to authorized entities and/or to store only data from trusted sources in the memory area and/or to store only data in the memory area which has passed a data integrity and/or data authenticity test.

In this regard, the term "interface", can refer to a combination of electrical or optical terminals via which signals can be input and/or output (by the apparatus), and a device connected to the terminals which is configured to derive input data from the input signals or to derive output signals from output data. The electrical or optical terminals may be integrated into a socket or plug. The electrical terminals may be clamp terminals and, in particular, spring-type clamp terminals.

Furthermore, the term "bus" can refer to a wired transmission medium which is used jointly by multiple apparatus for the transmission of data. A bus may, for example, comprise one or more electrical or optical lines to which the apparatus are connected and which are used by the devices for data transmission via electrical or optical signals based on multiplexing, wherein the allocation of transmission resources (e.g. transmission times) is determined on the basis of a bus protocol. The bus protocol may, for example, provide that the apparatus are allowed to transmit data during predetermined transmission windows or cooperatively determine resource usage during runtime. In particular, the bus protocol may contain provisions for avoiding or resolving collisions that (would) occur if two apparatus claimed (the same) transmission resources at the same time. For example, the bus protocol may specify that the allocation of transmission resources during runtime is determined by a higher-level unit (master) or divide transmission times into transmission rounds and assign the transmission resources permanently within these rounds.

Furthermore, the term "microcontroller" can refer to a functional unit comprising a processor, a memory and digital/analog input/output components, formed as an integrated circuit (IC).

Moreover, the term "memory chip" can refer to a memory formed as an integrated circuit, which may be arranged in a housing (made of insulating material) and the terminals of which may extend through the housing to the outside. Furthermore, the term "memory area" can refer to a contiguous address area, wherein the addresses of the address area are assigned to one or more memory elements of the memory.

Moreover, the term “authorized entity” can refer to an entity which has been successfully authenticated by the microcontroller and is known to the microcontroller as authorized. Furthermore, the term “trusted source” can refer to a source which is registered as trustworthy in the apparatus or which is classified as trustworthy by a registered source.

Moreover, the term "data integrity test" can refer to applying a hash function to the data and a comparison of a hash value generated when applying the hash function to the data with a hash value provided with (e.g., appended to) the data.

The interface may be configured as an EtherCAT slave controller.

The data may embody a configuration of the EtherCAT slave controller. For example, the EtherCAT slave controller may be assigned, via configuration data, an identification and, if necessary, information about the functionality of the apparatus. For example, the configuration data may comprise information regarding, and/or a description of, the properties of the apparatus and, in particular, a structure of the process data provided by the apparatus.

The emulated memory chip may be an EEPROM. In particular, the microcontroller may merely emulate the memory chip and manage access to the emulated memory chip.

The microcontroller (emulating the memory module) may be connected to the interface via a two-wire bus. The two-wire bus may be an Inter-Integrated Circuit (I²C) bus. For example, a terminal (pin) of the microcontroller may be connected to a clock line and another terminal (pin) to a data line of the I²C bus.

The microcontroller (emulating the memory module) may also be connected to the interface via a Serial Peripheral Interface (SPI) bus.

The microcontroller may be configured to grant an entity access to the memory area when the entity has been successfully authenticated by the microcontroller and recognized as an authorized entity. The microcontroller may be configured to request a proof of identity from the entity and to use the proof of identity to determine whether the entity is authorized.

The microcontroller may be configured to store the data in the memory area only if the data to be stored in the memory area has been determined to originate from a trusted source. For example, the microcontroller may be configured to verify with a signature/key that the data comes from a trusted source.

According to a second aspect, an apparatus may comprises a microcontroller, wherein the microcontroller is configured to emulate an EEPROM provided for the non-volatile storage of configuration data of an EtherCAT slave controller, wherein the microcontroller is further configured to restrict access to a memory area provided for storing the configuration data to authorized entities and/or to store only configuration data from trusted sources in the memory area, wherein the microcontroller is further configured to receive the configuration data via an Inter-Integrated Circuit, I2C, bus from the EtherCAT slave controller.

According to a third aspect, a microcontroller may comprise a first terminal and a second terminal, wherein the first terminal is configured for input of a clock signal and the second terminal is configured for input and/or output of a data signal, wherein the microcontroller is configured to emulate a memory chip which is configured for the non-volatile storage of data, to be received via the terminals, in a specific memory area of the memory chip, and is further configured to check, prior to any change to the specific memory area of the emulated memory chip, whether the change is initiated by an authorized entity and/or the data to be stored in the specific memory area originates from a trusted source and/or the data to be stored in the specific memory area is uncorrupted.

In this regard, the term "clock signal" can refer to a signal by which the microcontroller and a communication partner (e.g. an EtherCAT slave controller) synchronize to a common data transmission clock. For example, the clock signal may be generated by a communication partner and used by another communication partner receiving the clock signal to output or input data, taking into account a data transmission timing specified by the clock signal. In this regard, the term "data signal" can refer to a signal from which data can be derived taking into account the clock signal.

Furthermore, the term "uncorrupted" can refer to a state of data in which applying a hash function to the data and comparing a hash value generated when applying the hash function to the data with a hash value provided with (e.g., appended to) the data results in a match of the hash values.

The microcontroller may further be configured to store the data in the specific memory area only if the entity has been successfully authenticated by the microcontroller and recognized as an authorized entity. For example, the entity may have used the hash value over the data to generate a signature for the data using a signature procedure, which may then be verified by the microcontroller.

The microcontroller may be further configured to request a proof of identity from the entity and to use the proof of identity to determine whether the entity is authorized,

The microcontroller may be further configured to store the data in the specific memory area only if the data to be stored in the specific memory area has been determined to originate from a trusted source.

The microcontroller may be further configured to use a key to verify that the data originates from the trusted source.

The terminals may be configured for connection with a bus. For example, a terminal (pin) of the microcontroller may be connected to a clock line and another terminal (pin) to a data line of a bus. The bus may be a two-wire bus, in particular an Inter-Integrated Circuit (I²C) bus.

The emulated memory chip may be an EEPROM. In particular, the microcontroller may merely emulate the memory chip and manage access to the emulated memory chip.

Furthermore, it is understood that the features described in connection with the apparatus and the microcontroller may also be features of a method relating to the use of the apparatus and the microcontroller, respectively.

Further scope of applicability of the present invention will become apparent from the detailed description given hereinafter. However, it should be understood that the detailed description and specific examples, while indicating preferred embodiments of the invention, are given by way of illustration only, since various changes, combinations and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a bus system comprising an apparatus and a microcontroller;

FIG. 2 shows a bus system comprising an apparatus and a microcontroller;

FIG. 3 illustrates how the microcontroller emulating the memory chip verifies whether a storing of data has been initiated by an authorized entity;

FIG. 4 shows a possible modification of the bus system shown in FIG. 1;

FIG. 5 shows a possible modification of the bus system shown in FIG. 2; and

FIG. 6 illustrates how the microcontroller emulating the memory chip verifies whether the data to be stored originates from a trusted source.

### DETAILED DESCRIPTION

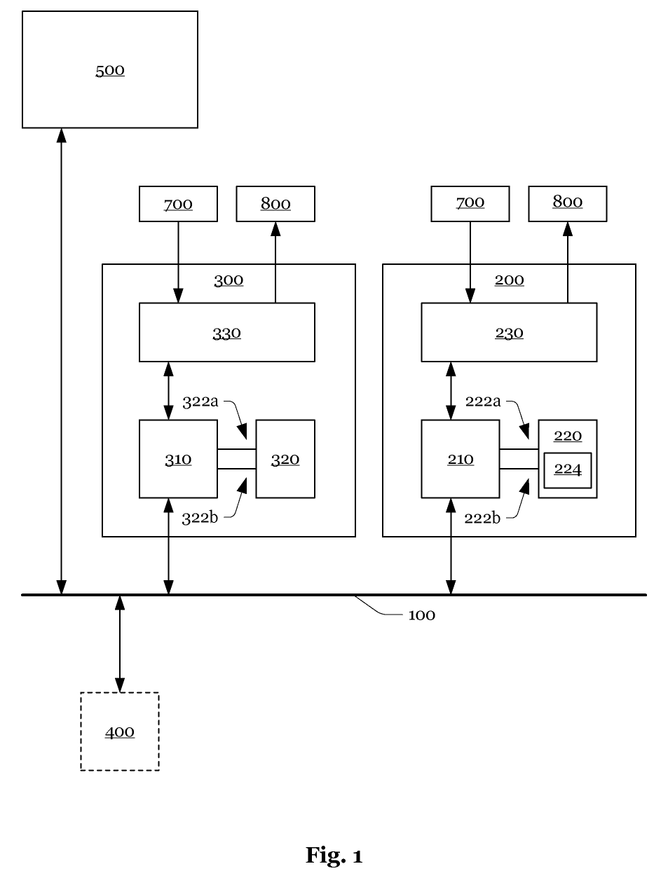

FIG. 1 shows a schematic illustration of components of an exemplary EtherCAT system (according to IEC standard 61158) comprising a bus 100 and several bus nodes which are connected to each other (in terms of communication technology) via the bus 100. The shown bus nodes comprise an apparatus 200 in accordance with the invention which assumes the role of an EtherCAT slave, an apparatus 300 not in accordance with the invention which also assumes the role of an EtherCAT slave, and two further entities 400 and 500. Whereas entity 500, which assumes the role of an EtherCAT master, functions correctly and its presence in the bus system is intended, it is assumed in the following that entity 400 does not function correctly or that its presence in the bus system is unwanted (which is indicated in the illustration in FIG. 1 by the use of dashed lines) and that entity 400 (like entity 500) assumes the role of an EtherCAT master. For example, entity 400 may be faulty(ly) (configured), infected with malware, or connected to bus 100 by an unauthorized person to manipulate the bus system.

The apparatus 200 comprises an interface 210 (in the form of an ASIC, an IP in an FPGA or a soft IP in a TI-PRU) via which it is connected to the bus 100. The interface may, for example, be configured as an EtherCAT slave controller. The apparatus 200 further comprises a microcontroller 220 which emulates a memory chip and is connected to the interface 210 via a two-wire bus (for example, an I²C bus) that is connected to two terminals 222a and 222b of the microcontroller 220 and is thus accessible to other bus nodes via the bus 100. The microcontroller 220 comprises a memory area 224, which is provided (exclusively or among other things) for storing the data intended for the emulated memory chip. In the following, it may be assumed that the memory module to be emulated is provided (exclusively or among other things) for storing security-relevant (in the sense of cybersecurity) data.

To protect the security-relevant data, the microcontroller 220 may take measures regarding access to memory area 224 (which is intended for storing the security-relevant data) that go beyond simply emulating a memory chip. For example, the memory chip emulated by the microcontroller 220 may be an EEPROM, which (in principle) any other bus node could access but for the access restrictions implemented by the microcontroller 220. To protect the security-relevant data, the microcontroller 220 may, for example, be configured to allow only authorized entities to store data in the memory area 224, which is provided for storing the security-relevant data, and/or to allow data to be stored in the memory area 224 only if the data to be stored originates from a trusted source.

The apparatus 200 may further comprise a circuit 230 which may be configured to provide data and/or services to the bus nodes. Thus, a sensor 700 may be connected to an input of circuit 230, and circuit 230 may be configured to derive data from signals received via the input and to transmit the data to a bus node via interface 210. Furthermore, an actuator 800 may be connected to an output of the circuit 230, and the circuit 230 may be configured to derive signals from data received via the interface 210 from a bus node and to control the actuator 800 by outputting the derived signals at the output. The circuit 230 may also be configured to control the actuator 800 within a framework given by certain specifications (received via the interface 210) based on the signals received from the sensor 700.

Apparatus 300 corresponds in structure and function to apparatus 200 but may differ from apparatus 200 in that apparatus 300 comprises a memory module 320 instead of the microcontroller 220, which emulates a memory module. In contrast to the write access to memory area 224, write access to (non-emulated) memory module 320 is not restricted, such that, in principle, all bus nodes acting as masters can write data to memory module 320. It is therefore possible that entity 400 writes faulty data to memory module 320, which causes interface 310 to be incorrectly configured and makes communication with apparatus 300 via bus 100 difficult or impossible. Furthermore, a faulty configuration of interface 310 may lead to the circuit 330 no longer providing data or providing faulty data, or to the actuator 800 being incorrectly controlled.

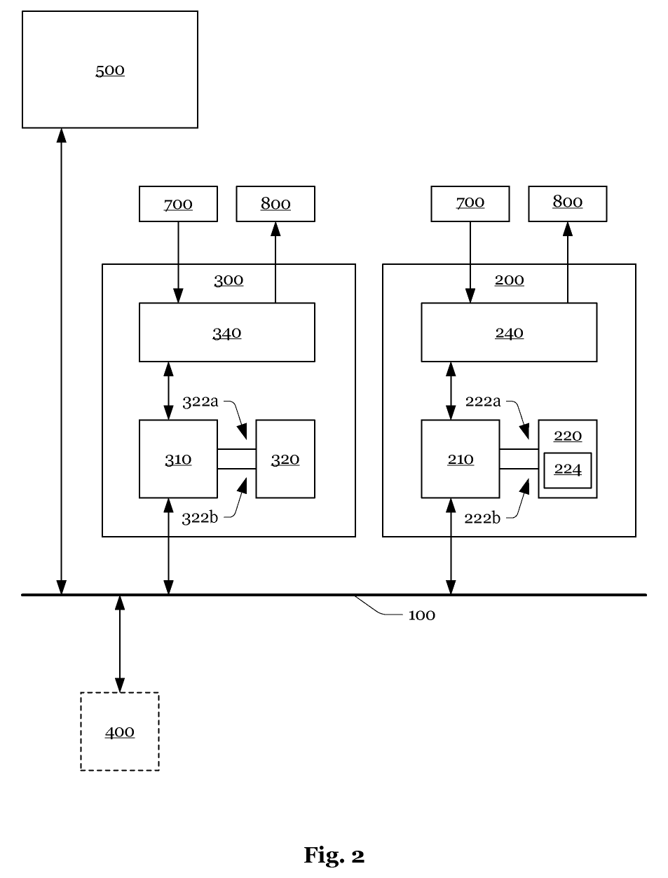

FIG. 2 shows a possible modification of apparatus 200 and 300 shown in FIG. 1, wherein the circuits 230 and 330 are microcontrollers 240 and 340 respectively. The microcontrollers 240 and 340 may be configured to input and output any input and output signals (analog I/Os, rotary encoders, timestamping, etc.).

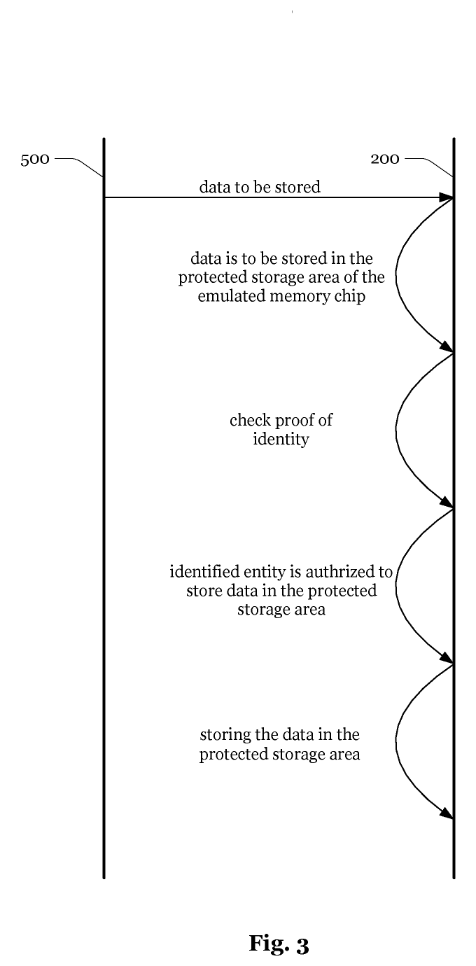

FIG. 3 schematically illustrates how the microcontroller 220, emulating the memory module, checks whether the entity 500, which initiates data storage, is authorized to do so. If the apparatus receives 200 data, which are to be stored in the memory module to be emulated by the microcontroller 220, in a file, the file may be transferred to the microcontroller 220, which may initially store the data temporarily and only save it in non-volatile memory if a specific page to be written, e.g. the last one or a page with a specific address, contains valid information for authenticating the author of the file and the author is authorized to store the file. Because entity 500 is functioning correctly, the presence of entity 500 in the bus system is intended, and entity 500 is known to the microcontroller as authorized, the microcontroller 220 emulating the memory chip may store the data in memory area 224 of the non-volatile memory. Since the microcontroller does not recognize unit 400 as authorized, the microcontroller 220 emulating the memory chip would not store data from unit 400 in memory area 224 of the non-volatile memory.

Furthermore, information indicating whether and/or for which address ranges authentication of the author is not required may be contained, for example, in an address range provided by EtherCAT for the user. This information could be overwritten by the data. Furthermore, it may be provided that no authentication is required for read access to the memory area 224.

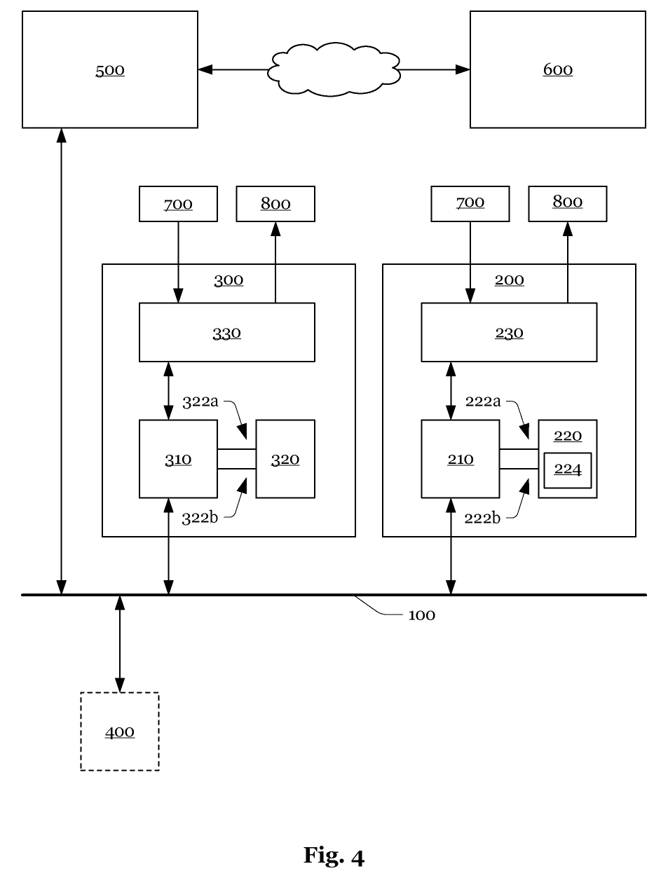

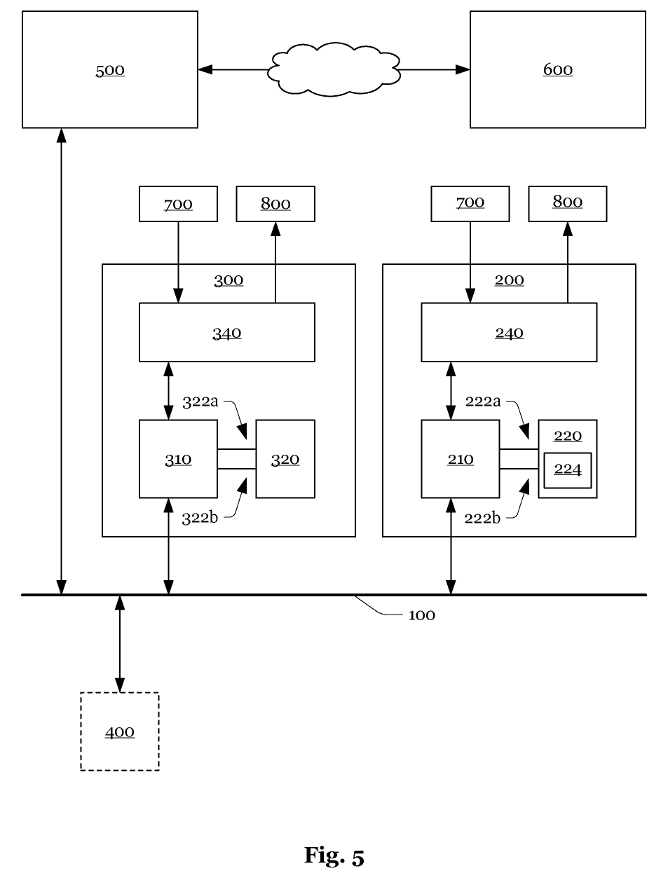

FIG. 4 and FIG. 5 show a possible modification of the system shown in FIG. 1 and FIG. 2 respectively. Here, the data is signed by entity 600, which is a trusted source, and this signature can be verified by the microcontroller 220 with a verification key. If the microcontroller 220 recognizes, based on the verification, that the data originates from the trusted source, the microcontroller 220, which emulates the memory chip, may store the data in the memory area 224 of the non-volatile memory. Since data transferred from entity 400 to microcontroller 220 is not recognized as originating from a trusted source, microcontroller 220, which emulates the memory chip, would not store the data in the memory area 224 of the non-volatile memory.

Furthermore, information indicating whether and/or for which address ranges only data from a trusted source is accepted may be contained, for example, in an address range provided by EtherCAT for the user. Furthermore, different verification keys may be available for different address ranges. It may also be envisaged that the verification keys are created or modified by storing data in the memory area 224 of the non-volatile memory.

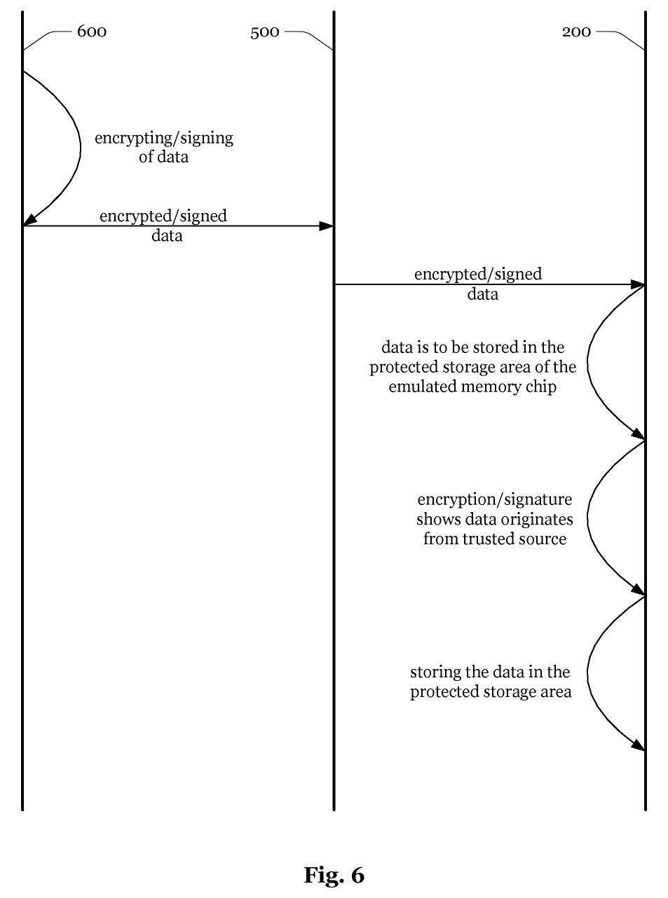

FIG. 6 illustrates schematically how the microcontroller emulating the memory chip may verify whether the data to be stored originates from a trusted source. If the apparatus 200 receives data, which is to be stored in the memory module to be emulated by the microcontroller 220, in an encrypted or signed file, the file may be transferred to the microcontroller 220, which may initially store the file temporarily and only save the file in non-volatile memory if the encryption or signature has been verified and the verification has shown that the data comes from a trusted source.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An apparatus comprising:
an interface configured as a bus interface; and
a microcontroller configured to emulate a memory chip that is provided for non-volatile storage of data to be received via the interface;
wherein the microcontroller is further configured to restrict access to a memory area provided for non-volatile storage of the data to authorized entities and/or to store in the memory area only data from trusted sources and/or to store in the memory area only data which has passed a data integrity and/or data authenticity test.

2. The apparatus of claim 1, wherein the interface is configured as an EtherCAT slave controller.

3. The apparatus of claim 2, wherein the data embody a configuration of the EtherCAT slave controller.

4. The apparatus of claim 1, wherein the memory chip is an EEPROM.

5. The apparatus of claim 1, wherein the microcontroller is connected to the interface by a two-wire bus.

6. The apparatus of claim 5, wherein the two-wire bus is an Inter-Integrated Circuit, I²C, bus.

7. The apparatus of claim 1, wherein the microcontroller is configured to grant an entity access to the memory area when the entity has been successfully authenticated by the microcontroller and recognized as an authorized entity.

8. The apparatus of claim 7, wherein the microcontroller is configured to request a proof of identity from the entity and to use the proof of identity to determine whether the entity is authorized.

9. The apparatus of claim 1, wherein the microcontroller is configured to store the data in the memory area only if the data to be stored in the memory area has been determined to originate from a trusted source.

10. The apparatus of claim 9, wherein the microcontroller is configured to use a key to verify that the data originates from the trusted source.

11. An apparatus comprising:
a microcontroller configured to emulate an EEPROM provided for non-volatile storage of configuration data of an EtherCAT slave controller, the microcontroller being further configured to:
restrict access to a memory area intended for storing the configuration data, to authorized entities and/or to store only configuration data from trusted sources in the memory area; and
to receive the configuration data via an Inter-Integrated Circuit, I²C, bus from the EtherCAT slave controller.

12. A microcontroller comprising:
a first terminal; and
a second terminal,
wherein the first terminal is configured for input of a clock signal and the second terminal is configured for input and/or output of a data signal, and
wherein the microcontroller is configured to emulate a memory chip which is configured for non-volatile storage of data received via the terminals in a specific memory area of the memory chip and is further configured to check, prior to any change to the specific memory area of the emulated memory chip, whether the change is initiated by an authorized entity and/or the data to be stored in the specific memory area is from a trusted source and/or the data to be stored in the specific memory area is uncorrupted.
